(19) United States
(12) Patent Application Publication
(10) Pub. No.: US 2022/0128409 A1
(43) Pub. Date: Apr. 28, 2022

(54) RAMAN SPECTROSCOPY

(71) Applicant: Raytheon Company, Waltham, MA (US)

(72) Inventors: Richard Moro, JR., Melrose, MA (US); Erik D. Johnson, Boston, MA (US); Bernard Harris, Boynton Beach, FL (US); Jeffrey R. Laroche, Lowell, MA (US)

(21) Appl. No.: 17/081,047

(22) Filed: Oct. 27, 2020

(51) Int. Cl. G01J 3/44; G01N 21/65

(52) U.S. Cl. CPC G01J 3/4412; G01N 21/658

(57) ABSTRACT

Disclosed herein are Raman spectrographic systems and methods of assembling Raman spectrographic systems. The Raman spectrographic system includes a light source to emit ultraviolet incident light into a waveguide, and an interaction region traversed by the waveguide and that holds a sample to be identified. A spectrometer detects Raman scatter from an output light in the waveguide emerging from the interaction region following interaction between the incident light and the sample and output a spectral response. The spectrometer includes an array of detectors. Each detector of the array of detectors is a silicon carbide (SiC) detector to obtain information that includes an intensity corresponding with a wavelength of the Raman scatter. A controller identifies the sample based on the spectral response from the array of detectors.

### BACKGROUND

The present disclosure relates to spectroscopy and, more particularly, to Raman spectroscopy.

The Raman effect is a change in wavelength of light (i.e., a Raman shift) that occurs when a light beam is deflected by molecules in a sample. Raman scattering can occur in two ways. If the emitted radiation from the sample is lower in frequency than the incident radiation into the sample (i.e., the scattered photons have less energy than the incident photons), this is called Stokes scattering. In this case, energy has been gained by the sample (i.e., the scattering medium). If the emitted radiation from the sample is higher in frequency than the incident radiation into the sample (i.e., the scattered photons have more energy than the incident photons), this is called anti-Stokes scattering. In this case, energy has been lost by the sample (i.e., the scattering medium). Generally, most light is not scattered at all but, instead, is transmitted in the direction of transmission of the incident light. Of the scattered light (i.e., light that is emitted from the sample in a direction other than the direction of the incident light), less than one percent of scattered photons demonstrate the Raman effect, with the majority of the Raman scatter being Stokes scattering. The vast majority of scattered photons demonstrate the Rayleigh effect in which the scattered photons retain the frequency and energy of the incident photons.

### SUMMARY

Disclosed herein are Raman spectrographic systems and methods of assembling Raman spectrographic systems. A non-limiting example of a Raman spectrographic system includes a light source to emit ultraviolet incident light into a waveguide, and an interaction region traversed by the waveguide and that holds a sample to be identified. A spectrometer detects Raman scatter from an output light in the waveguide emerging from the interaction region following interaction between the incident light and the sample and output a spectral response. The spectrometer includes an array of detectors. Each detector of the array of detectors is a silicon carbide (SiC) detector to obtain information that includes an intensity corresponding with a wavelength of the Raman scatter. A controller identifies the sample based on the spectral response from the array of detectors.

Another non-limiting example of a method of assembling a Raman spectrographic system includes arranging a light source to emit ultraviolet incident light into a waveguide, and arranging the waveguide to traverse an interaction region that holds a sample to be identified. The method also includes positioning a spectrometer to detect Raman scatter from an output light in the waveguide emerging from the interaction region following interaction between the incident light and the sample and to output a spectral response. An array of detectors is arranged as part of the spectrometer, each detector of the array of detectors being a silicon carbide (SiC) detector configured to obtain information that includes an intensity corresponding with a wavelength of the Raman scatter. A controller is configured to identify the sample based on the spectral response from the array of detectors.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a block diagram of a Raman spectroscopic system according to one or more embodiments;

FIG. 2 is a block diagram of an exemplary spectrometer of the Raman spectroscopic system according to one or more embodiments; and

FIG. 3 is an exemplary spectral response used for identification in the Raman spectroscopic system according to one or more embodiments.

### DETAILED DESCRIPTION

As previously noted, the Raman effect is an observable effect resulting from exposure of a sample to light. The sample can be identified by the spectral signature of the Raman scatter it generates. Embodiments of the systems and methods detailed herein relate to Raman spectroscopy. Raman spectroscopy of a biological sample (e.g., virus) may be performed at infrared (IR) or other wavelengths but generally calls for operation in the ultraviolet (UV) wavelength range. This is because, in the UV range, the expected low intensity of Raman scatter is distinguishable from higher-wavelength autofluorescence noise. However, UV light can destroy a biological sample. For example, UV light is used for disinfection. Thus, low-level UV such as the UVC range, which has a wavelength between 200 nanometers (nm) and 280 nm, is preferable. For example, the intensity of the Raman scatter is two orders of magnitude greater in the UVC range than in the infrared (IR) range. While Raman spectroscopy at UVC wavelengths facilitates identification of microbial species and subspecies, in addition to chemicals and other types of samples, the technique has traditionally been impractical because of the weakness of the signal. A high-gain silicon carbide (SiC) transistor, such as the transistor described in U.S. Pat. No. 10,665,703, facilitates effective detection of the Raman scatter and provides the spectral response sensitivity needed for effective Raman spectroscopy in the UVC range according to one or more embodiments. The Raman spectroscopy, according to one or more embodiments, is performed using a system on chip (SoC) implementation.

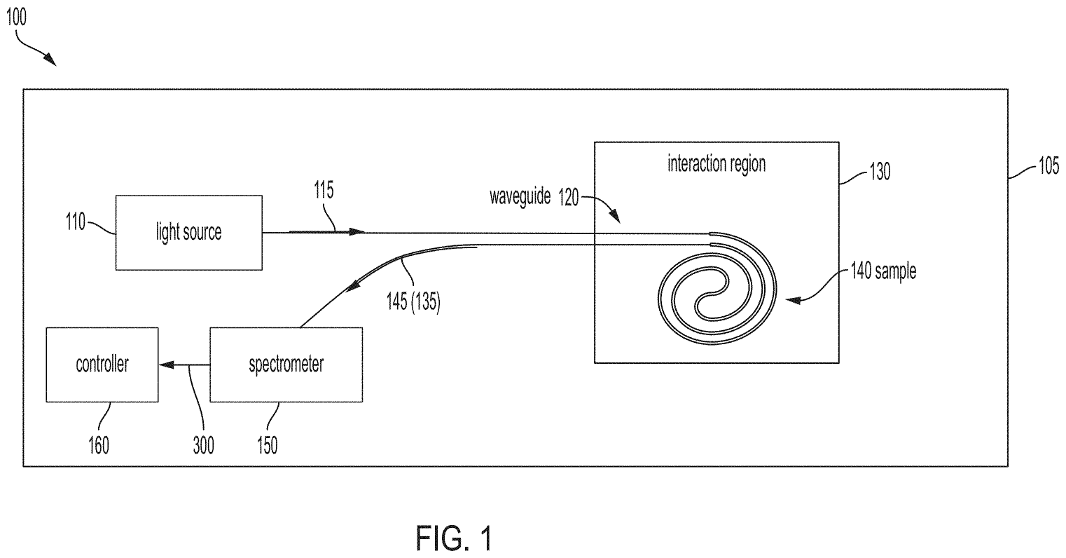

FIG. 1 is a block diagram of a Raman spectroscopic system 100 according to one or more embodiments. The Raman spectroscopic system 100 may be implemented as an integrated circuit (i.e., as a system on chip) 105, as shown in the exemplary embodiment. A light source 110 generates incident light 115 that is channeled via a waveguide 120 to an interaction region 130. The interaction region 130 includes a sample 140 that may be in an aqueous or gas medium, for example. According to an exemplary embodiment, the sample 140 may be exhaled breath condensate (EBC) and detection and identification of a virus (e.g., SARS-coV2 virus that causes COVID-19) may be of interest. In alternate embodiments, the sample 140 may be a chemical or any other material whose detection and identity is of interest. As shown, the waveguide 120 is arranged to take more than one path within the interaction region 130 in order to increase the interaction between the sample 140 and the incident light 115. When the incident light 115 interacts with the sample 140 in the interaction region 130, some of the output 145 that is generated by the interaction is Raman scatter 135. Other, more prevalent components of the output 145 include Rayleigh scatter and un-scattered incident light 115.

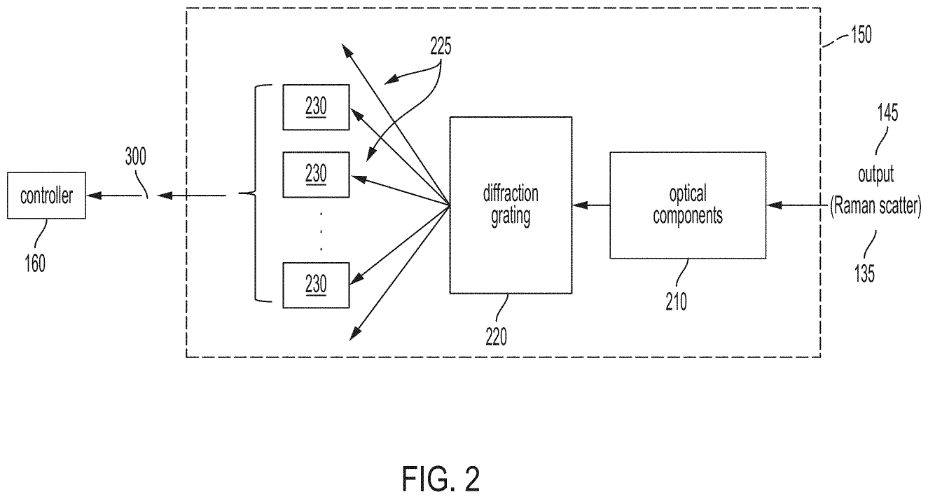

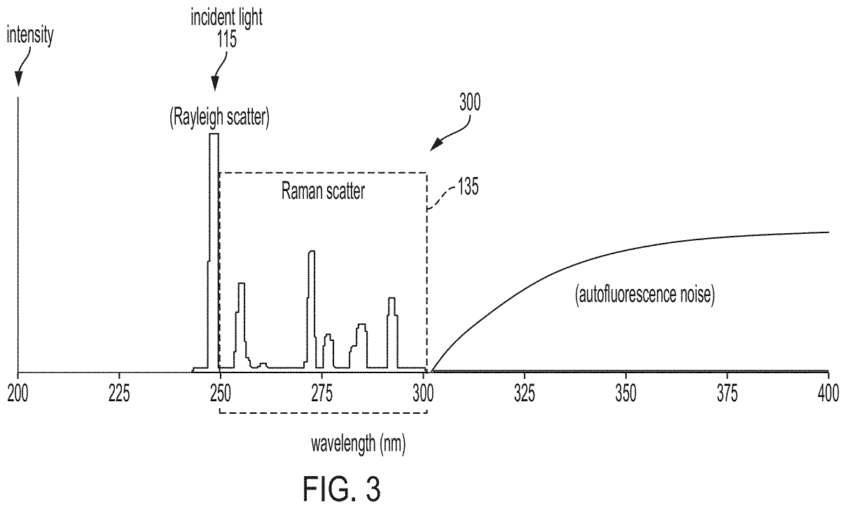

The Raman scatter 135 in the output 145 is the portion of interest and is detected by a spectrometer 150, which is further detailed with reference to FIG. 2. The spectrometer 150 separates the spectral components of the Raman scatter 135 to provide a spectral response 300, which is further discussed with reference to FIG. 3. A controller 160 maps the spectral response 300 obtained from the Raman scatter 135 by the spectrometer 150 to known spectra of materials (e.g., a library of spectral responses 300) in order to identify the sample 140 or identifies the spectral response 300 as an as-yet unidentified anomalous spectra. The controller 160 may include processing circuitry including one or more memory devices and one or more processors and may be implemented as a microprocessor or an integrated circuit, for example.

The light source 110 may be a laser diode, for example. The incident light 115 output by the light source 110 is in the UV spectrum according to an exemplary embodiment. Specifically, the incident light 115 may be UVC light, which has a wavelength between 200 nanometers (nm) and 280 nm. This range of wavelengths is absorbed by deoxyribonucleic acid (DNA), ribonucleic acid (RNA), and proteins. Thus, as previously noted, the UVC incident light 115 is effective when the Raman spectroscopy is applied to the identification of a virus in a given sample 140, for example. An exemplary light source 110 is a gallium nitride (GaN)-based laser diode that emits UV incident light 115 and is small enough to be incorporated on the chip 105 according to an exemplary SoC implementation of the Raman spectroscopic system 100. Another exemplary light source 110 is an SiC-based laser diode.

The interaction region 130 may include a roughened metal surface (e.g., gold (Au), silver (Ag), or aluminum (Al)) for holding the sample 140, for example. This may lead to surface-enhanced Raman scattering (SERS), which is an enhanced Raman scattering by molecules that are adsorbed on the rough metal surface or a nanostructure. The enhanced Raman scattering in SERS may provide orders of magnitude increases in Raman intensity, further facilitating the detection and identification according to one or more embodiments.

For example, the roughened surface or nanostructures could be formed by material deposition and lithographic etch and patterning techniques. The material deposition techniques can be by any suitable technique such as sputtering, evaporation, molecular beam epitaxy (MBE), metal organic chemical vapor deposition (MOCVD), and blanket deposition or selective atomic layer deposition (ALD). Lithographic patterning techniques can be by any suitable technique such as 248 nm or 193 nm or deep UV optical lithography, electron beam lithography, or imprint lithography. Pattern formation in conjunction with the lithography could be completed by wet or dry plasma etching in, for example, fluorine or chlorine containing chemistries. Selectively deposited ALD nanostructures can be formed using patterned block co-polymers or patterned hydrophilic/hydrophobic regions.

FIG. 2 is a block diagram of an exemplary spectrometer 150 of the Raman spectroscopic system 100 according to one or more embodiments. The output 145 from the interaction region 130, which includes Raman scatter 135, is collected and focused by optical components 210 of the spectrometer 150. The optical components 210 may include a mirror (e.g., concave spherical mirror), for example. A diffraction grating 220 of the spectrometer 150 then splits the focused light from the optical components 210 into light beams 225. The diffraction grating 220 is a type of optical component that disperses light projected onto it by the optical components 210 into its constituent wavelengths. Thus, each of the beams 225 is at a different wavelength or a narrow range of wavelengths and is output at a different angle, as shown.

The wavelength corresponding with every beam 225 may not be of interest. According to exemplary embodiments, the beam 225 associated with Rayleigh scatter, which has the same wavelength as the incident light 115, and beams 225 associated with autofluorescence noise are not of interest while only beams 225 associated with the wavelengths of Raman scatter 135 are of interest. An array of detectors 230 is part of the spectrometer 150. The array of detectors 230 is arranged to detect the intensity of light at the set of wavelengths (i.e., for the full set or a subset of beams 225) of interest, as shown.

Each detector 230 in the array is a SiC detector. As previously noted, the increased sensitivity of the detector 230 in the UVC wavelength range as compared with previously available UV detectors is what facilitates the identification of biological material via Raman spectroscopy according to one or more embodiments. The detector 230 is a negative-positive-negative (NPN) bipolar transistor and, thus, functions as a switch and amplifier, as explained. Generally, electrons flow from the emitter to the collector (i.e., current flows from the collector to the emitter) if current flows from the base to the emitter. Thus, the base to emitter current flow acts as a switch for current flow from the collector to the emitter. Further, the introduction of a small current flow from the base to the emitter results in a relatively much larger current flow from the collector to the emitter. Thus, the transistor acts as an amplifier.

Because light energy applied on semiconductor materials can generate electron-hole pairs and therefore current in the semiconductor materials, each of the beams 225 can activate the switch (i.e., inject charge into the base) and initiate current flow between the collector and emitter in the corresponding detector 230. Further, the resulting current value in each detector 230 depends on and thereby indicates the intensity of the light of the corresponding beam 225. This intensity indication at each detector 230 and the wavelength corresponding with each detector 230 makes up the spectral response 300 provided by the array of detectors 230. The spectral response 300 obtained by the array of detectors 230 is further discussed with reference to FIG. 3. This spectral response 300 is provided to the controller 160.

As previously noted, the controller 160 compares the spectral response 300 with known spectral responses 300 (e.g., in a pre-established library) to identify the sample 140. If the sample 140 cannot be identified by its spectral response 300, then the identification of the spectral response 300 as an anomalous spectrum may also be of interest. Further, the newly identified anomalous spectral response 300 may be added to the library or other document for future mapping. The ability to quickly and easily update the library of spectral responses 300 to facilitate newly identified materials represents an advantage of the approach according to the one or more embodiments.

FIG. 3 shows an exemplary spectral response 300 used for identification in the Raman spectroscopic system 100 according to one or more embodiments. The exemplary case shown in FIG. 3 involves the incident light 115 having a wavelength of 250 nm. Thus, Rayleigh scatter in the output 145 from the interaction region 130 will have the same wavelength, as indicated. Autofluorescence noise is indicated at wavelengths above 300 nm. The Raman scatter 135, which is detected by the array of detectors 230 and whose intensity at each wavelength is indicated in the spectral response 300, is at a wavelength range above 250 nm to approximately 300 nm. Specifically, Stokes Raman scatter, which has a lower frequency and, thus, higher wavelength than the incident light 115 is detected. In alternate embodiments, a different UVC wavelength may be generated by the light source 110. The wavelength of the incident light 115 is selected based on the response expected for the material of interest in the sample 140.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

1. A Raman spectrographic system comprising:
a light source configured to emit ultraviolet incident light into a waveguide of the system, wherein the system is implemented as a system on chip (SoC);
an interaction region defining an area of the chip and configured to hold a sample to be identified in the area, the waveguide traversing a two-dimensional path through the interaction region;
a spectrometer configured to detect Raman scatter from an output light in the waveguide emerging from the interaction region following interaction between the incident light and the sample and output a spectral response, the spectrometer including an array of detectors, each detector of the array of detectors being a negative-positive-negative (NPN) bipolar transistor silicon carbide (SiC) detector configured to obtain information that includes an intensity corresponding with a wavelength of the Raman scatter; and
a controller configured to identify the sample based on the spectral response from the array of detectors.

2. The system according to claim 1, wherein the interaction region is a roughened metal surface.

3. The system according to claim 1, wherein the light source is a gallium nitride (GaN)-based or a SiC-based laser diode.

4. The system according to claim 1, wherein the spectrometer includes optical components to collect and focus the output light.

5. The system according to claim 4, wherein the spectrometer includes a diffraction grating configured to separate the output light into a set of wavelengths or wavelength ranges output as corresponding beams at different angles.

6. The system according to claim 5, wherein the array of detectors of the spectrometer is arranged such that each detector of the array of detectors receives one of the beams and determines the intensity of the Raman scatter at the wavelength or wavelength range corresponding with the beam.

7. The system according to claim 6, wherein each detector of the array of detectors is a transistor and the intensity of the Raman scatter at the wavelength or wavelength range corresponding with the beam controls a current flow through the transistor.

8. The system according to claim 1, wherein the interaction region includes the sample in an aqueous or gas solution, and the sample is a virus.

9. The system according to claim 1, wherein the controller is configured to identify the sample by comparing the spectral response with known spectral responses.

10. The system according to claim 9, wherein the controller is configured to determine that the spectral response of the sample does not match any of the known spectral responses.

11. A method of assembling a Raman spectrographic system, the method comprising:
arranging a light source to emit ultraviolet incident light into a waveguide of the system, wherein the Raman spectrographic system is implemented as a system on chip (SoC);
arranging the waveguide to traverse a two-dimensional path through an interaction region that defines an area of the chip and holds a sample to be identified in the area;
positioning a spectrometer to detect Raman scatter from an output light in the waveguide emerging from the interaction region following interaction between the incident light and the sample and to output a spectral response;
arranging an array of detectors as part of the spectrometer, each detector of the array of detectors being a negative-positive-negative (NPN) bipolar transistor silicon carbide (SiC) detector configured to obtain information that includes an intensity corresponding with a wavelength of the Raman scatter; and
configuring a controller to identify the sample based on the spectral response from the array of detectors.

12. The method according to claim 11, further comprising forming the interaction region as a roughened metal surface.

13. The s method according to claim 11, wherein the arranging the light source includes arranging a gallium nitride (GaN)-based or SiC-based laser diode.

14. The method according to claim 11, wherein the positioning the spectrometer includes arranging optical components to collect and focus the output light.

15. The method according to claim 14, wherein the positioning the spectrometer further includes arranging a diffraction grating to separate the output light into a set of wavelengths or wavelength ranges output as corresponding beams at different angles.

16. The method according to claim 15, wherein the arranging the array of detectors of the spectrometer includes positioning each detector of the array of detectors to receive one of the beams and to determine the intensity of the Raman scatter at the wavelength or wavelength range corresponding with the beam.

17. The method according to claim 16, wherein the arranging the array of detectors includes arranging a transistor as each detector such that the intensity of the Raman scatter at the wavelength or wavelength range corresponding with the beam controls a current flow through the transistor.

18. The method according to claim 11, further comprising holding the sample in an aqueous or gas solution in the interaction region, wherein the sample is a virus.

19. The method according to claim 11, wherein the configuring the controller includes configuring the controller to identify the sample by comparing the spectral response with known spectral responses.

20. The method according to claim 19, wherein the configuring the controller includes configuring the controller to determine that the spectral response of the sample does not match any of the known spectral responses.
